(19) United States
(12) Patent Application Publication
(10) Pub. No.: US 2025/0386415 A1
(43) Pub. Date: Dec. 18, 2025

(54) A LIGHTING DEVICE COMMISSIONING METHOD

(71) Applicant: SIGNIFY HOLDING B.V., EINDHOVEN (NL)

(72) Inventor: LEENDERT TEUNIS ROZENDAAL, VALKENSWAARD (NL)

(21) Appl. No.: 18/877,403

(22) PCT Filed: Jun. 15, 2023
(86) PCT No.: PCT/EP2023/066126

§ 371 Date: Dec. 20, 2024

(30) Foreign Application Priority Data
Jun. 21, 2022 (EP) 22180125.1

(51) Int. Cl. H05B 47/175; H05B 47/155; H05B 47/16; H05B 47/165; H05B 47/19

(52) U.S. Cl. CPC H05B 47/199; H05B 47/155; H05B 47/16; H05B 47/165; H05B 47/19; H05B 47/1965

(57) ABSTRACT

A method of commissioning of a number, n, of new lighting devices (10) joining or being added to a network, where n is an integer equal to or larger than 2, where the network comprises at least one bridge device (9) and a commissioning device (30), and where the method comprises determining (101), for each new lighting device (11, 12, 13, 14), at or by the new lighting device (11, 12, 13, 14), a first time, t1, at which the new lighting device (11, 12, 13, 14) is powered on, or a value derived from the first time, t1, obtaining (102), by the commissioning device (30), the first time, t1, or the value derived from the first time, t1, and displaying (103), by the commissioning device (30), on a user interface (4), the new lighting devices (11, 12, 13, 14), wherein the order of the new lighting devices (11, 12, 13, 14) as displayed on the user interface (4) is defined by the first time, t1, or the value derived from the first time, t1, as obtained by the commissioning device (30).

### FIELD OF THE INVENTION

The invention relates to a method of commissioning of a number, n, of new lighting devices joining or being added to a network, where n is an integer equal to or larger than 2, and where the network comprises a commissioning device. The invention further relates to a corresponding lighting device commissioning system.

### BACKGROUND OF THE INVENTION

A common lighting device system for domestic and professional use alike is a lighting device system comprising a plurality of lighting devices forming a network and being connected to a bridge and controlled centrally on a data processing device, typically through an app running on the data processing device. In connection with such a system, it is often necessary to modify existing lighting devices, typically by exchanging a defunct light bulb, and to add new lighting devices to the lighting device system.

When a user mounts a number of new lighting devices, such as screws in a bulb or plugs in a power cord to a lamp, the user must then bring (commission) the new lighting devices into the lighting device system using the app. During commissioning, the app will instruct the bridge to open the network of lighting devices, and the various new lighting devices will join the network one-by-one, in random order.

Then, those new lighting devices will be placed in the bridge's database in the same order as found, so also in a random order. The new lighting devices will also be shown on the user interface (UI) of the app in the same order as found, so also in a random order.

Following this, the user has to (re) name the lighting devices, group them, etc. When the number of lighting devices is large, this becomes a cumbersome job, since the lighting devices will be in random order and not in the order in which they were mounted. Also, the user will most likely remember the order in which the new lighting devices were mounted and have that as mental model. This random ordering is caused by the inherent randomness when a collection of new lighting devices joins an open network.

US 2014/300276 A1 discloses a lighting system comprising luminaires installed at individual locations in premises. The lighting system is commissioned by arranging auxiliary commissioning devices in the premises at spaced apart locations and a central controller and forming them into a wireless local network. The auxiliary commissioning devices each include a sensor to detect light from the luminaires. With a central controller, the locations of the auxiliary commissioning devices are established in relation to the premises, for example by using ranging on the basis of signal strengths of the auxiliary commissioning devices in the local network. Light emitted from the luminaires is detected individually with the sensors of the auxiliary commissioning devices such as to associate the luminaires with individual ones of the auxiliary commissioning devices. It is desired to provide a method and a system with which it is made possible for the user to see or be presented with the new lighting devices in the order the user has mounted them.

### SUMMARY OF THE INVENTION

It is an object of the present invention to overcome this problem, and to provide a method and a system with which it is made possible for the user to see or be presented with the (new) lighting devices in the order the user has mounted them.

According to a first aspect of the invention, this and other objects are achieved by means of a method of commissioning of a number, n, of new lighting devices joining or being added to a network, where n is an integer equal to or larger than 2, where the network comprises a commissioning device, and where the method comprises: determining, for each new lighting device, at or by the new lighting device, a first time, t1, at which the new lighting device is powered on, or a value derived from the first time, t1; obtaining, by the commissioning device, the first time, t1, or the value derived from the first time, t1; and displaying, by the commissioning device, on a user interface, the new lighting devices, wherein the order of the new lighting devices as displayed on the user interface is defined by the first time, t1, or a value derived from the first time, t1, as obtained by the commissioning device.

Thereby, and in particular by determining and obtaining, by a commissioning device, a first time, t1, or a value derived from the first time, t1, and by using the first time, t1, or the value derived from the first time, t1, as a basis for determining an order of display of the lighting devices, as described above, a method is provided with which it is made possible for the user to see or be presented with the new lighting devices in the order the user has mounted them assuming that mounting includes providing power to the lighting devices, or at least the order in which the lighting devices are powered up.

In an embodiment, the first time, t1, at which the new lighting device is powered on is any one of the time at which the new lighting device is powered on for the first time, and the time at which the respective new lighting device is powered on for the first time after the respective new lighting device has been reset to factory defaults.

Thereby, the first time, t1, may be determined by the new lighting device in a particularly simple and precise manner.

In an embodiment, the method further comprises: obtaining, by the commissioning device, for each new lighting device, at least one of a second time, t2, at which the network opens for lighting devices to join the network, and a third time, t3, at which the new lighting device is selected by a user by using the central commission device; determining, by the commissioning device, for each new lighting device, the amount of time, Δt, elapsed from the first time, t1 to at least one of the second time, t2, and the third time, t3; and, displaying, by the commissioning device, on a user interface, the new lighting devices, where the order of the new lighting devices as displayed on the user interface is defined by the amount of time, Δt, as determined by the commissioning device.

Thereby, the only change to the commissioning device needed is related to enabling the commissioning device to read out the first time, t1, and one of the second time, t2, and the third tome, t3, from the lighting devices, which amounts to adding a new wireless command to the hardware or software of an existing commissioning device. Therefore, such a method is particularly simple and straight forward to implement or retrofit in an existing lighting device system.

In an embodiment, the method further comprises: for each new lighting device, at each new lighting device, obtaining at least one of a second time, t2, at which the network opens for lighting devices to join the network, and a third time, t3, at which the new lighting device is selected by a user by using the central commission device; determining, by each new lighting device, the amount of time, Δt, elapsed from the first time, t1 to at least one of the second time, t2, and the third time, t3, obtaining, by the commissioning device, for each new lighting device, the amount of time, Δt, elapsed from the first time, t1 to at least one of the second time, t2, and the third time, t3; and, displaying, by the commissioning device, on a user interface, the new lighting devices, where the order of the new lighting devices as displayed on the user interface is defined by the amount of time, Δt, as determined by the respective new lighting device.

Thereby, the only change to the commissioning device needed is related to enabling the commissioning device to read out the amount of time, Δt, from the lighting devices, which amounts to adding a new wireless command to the hardware or software of an existing commissioning device. Therefore, such a method is particularly simple and straight forward to implement or retrofit in an existing lighting device system.

In an embodiment, the first time, t1, is obtained by the commissioning device reading out the first time, t1, from each new lighting device.

Alternatively, the first time, t1, may be determined by each new lighting device measuring and broadcasting or unicasting the first time, t1.

With either of these embodiments, the commissioning device is enabled to obtain the first time, t1, in a particularly simple manner.

In an embodiment, the first time, t1, is determined by the light emitted by a new lighting device exhibiting a pattern indicative of the first time, t1, and the commissioning device comprising a detecting device configured to detect the pattern indicative of the first time, t1.

In an embodiment, the second time, t2, is determined by the light emitted by a new lighting device exhibiting a pattern indicative of the second time, t2, and the commissioning device comprising a detecting device configured to detect the pattern indicative of the second time, t2.

In an embodiment, the third time, t3, is determined by the light emitted by a new lighting device exhibiting a pattern indicative of the third time, t3, and the commissioning device comprising a detecting device configured to detect the pattern indicative of the third time, t3.

In an embodiment, the amount of time, Δt, elapsed from the first time, t1 to at least one of the second time, t2, and the third time, t3 is determined by the light emitted by a new lighting device exhibiting a pattern indicative of the amount of time, Δt, and the commissioning device comprising a detecting device configured to detect the pattern indicative of the amount of time, Δt.

Thereby, the commissioning device is enabled to determine one or more of the first time, t1, the second time, t2, the third time, t3, and the amount of time, Δt, in a particularly simple manner using detecting devices which are most often already present in the commissioning device. For instance, the commissioning device may be a data processing device, such as a mobile telephone, a tablet computer or a laptop computer, with a suitable commissioning app, and the detecting device may be a camera of the mobile telephone, tablet computer or laptop computer.

In an embodiment, one or more of the pattern indicative of the first time, t1, the pattern indicative of the second time, t2, the pattern indicative of the third time, t3, and the pattern indicative of the amount of time, Δt, is any one or more of a visual light communication (VLC) pattern and a stroboscopic pattern, and the detecting device is a camera.

Thereby, the commissioning device is enabled to determine the first time, t1, in a particularly simple manner using a detecting device which is most often by standard present in the commissioning device.

In an embodiment, the step of displaying, by the commissioning device, on a user interface, the new lighting devices comprises entering the new lighting devices into a database in ascending order of the determined first time, t1, or in descending order of the determined amount of time, Δt, such that the order in which the new lighting devices are displayed on the user interface will match the order in which the new lighting devices were powered on.

Thereby, a method is provided with which it is made possible for the user to see or be presented with the (new) lighting devices in the order the user has mounted them or powered them up in a particularly simple manner and with a particularly high certainty for obtaining the correct desired order.

In an embodiment, the new lighting devices join or are added to the network in a random order.

Thereby, a method is provided with which the above advantages are obtained in a particularly simple manner.

In an embodiment, the new lighting devices join or are added to the network with a delay, k*(t2−t1), the delay being chosen such that the new lighting devices will join or are added to the network in the order in which they were powered up.

Thereby, a method is provided with which also the time at which the respective new lighting devices join or are added to the network may be used by the commissioning device to determine the order in which the lighting devices are to be displayed. It is noted that this means that the lighting devices will in effect join the network in reverse order, that is the last lighting device mounted has lowest value of t2−t1 and would therefore join the network first. Therefore, in practice, either the list displayed to the user on the user interface will have the last lighting device mounted on top, or the commissioning device may be configured to perform an inversion of the order of the list such as to place the lighting device joining first at the top of the list. Thereby, it is made possible to obtain the correct desired order in a particularly simple manner and with a particularly high certainty.

Furthermore, no changes to a commissioning device already being in use in an existing network are needed since the new lights will join the network in the wanted order. Therefore, such a method is particularly simple and straight forward to implement or retrofit in an existing lighting device system, since it does not warrant any change in the commissioning device.

In an embodiment, the method further comprises: positioning a camera in such a way that the camera overlooks the area where the new lighting devices are to be mounted; during mounting of the lighting devices, by the camera, picking up light from the new lighting devices; determining, based on the light picked up by the camera, the order in which the new lighting devices were mounted; and, based on the determined order in which the new lighting devices were mounted, controlling the new lighting devices one by one in order to correlate the position of the respective new lighting devices as entered in the database of the commissioning device with the actual position of the respective new lighting devices.

Thereby, a method is provided with which it is made possible to obtain the data needed for establishing the correct desired order in a particularly simple manner and with a particularly high certainty and further by using a camera often being present by standard in the commissioning device.

In an embodiment, the method further comprises, based on the correlated positions, sorting the entries for the new lighting devices in the database of the commissioning device in the determined order in which the new lamps were mounted.

Thereby, a method is provided with which it is made possible to obtain and display the correct desired order in a particularly simple manner and with a particularly high certainty.

In an embodiment, the network is a Zigbee-based network.

In an embodiment, the network is a Thread-based network.

In an embodiment, the network is a Wi-Fi-based network.

In an embodiment, the network uses Bluetooth mesh technology.

In an embodiment, the network uses Bluetooth Low Energy.

In an embodiment, the commissioning device is a data processing device, such as any one of a mobile telephone, a tablet computer and a laptop computer. The commissioning device may comprise, and in operation run, a lighting device commissioning app.

In an embodiment, the network further comprises a number, m, of previously added lighting devices, where m is an integer equal to or larger than 1.

The invention further relates to a lighting device system comprising a network and a number, n, of new lighting devices to be joining or to be added to the network, where n is an integer equal to or larger than 2, the network comprising a commissioning device, and where each new lighting device, is configured to determine a first time, t1, at which the new lighting device is powered on, or a value derived from the first time, t1, the commissioning device is configured to obtain the first time, t1, or the value derived from the first time, t1, and the commissioning device is configured to display, on a user interface, the new lighting devices, wherein the order of the new lighting devices as displayed on the user interface is defined by the first time, t1, or the value derived from the first time, t1, as obtained by the commissioning device.

In an embodiment, the commissioning device comprises the user interface.

In an embodiment of the system, the commissioning device is furthermore configured to obtain, for each new lighting device, at least one of a second time, t2, at which the network opens for lighting devices to join the network, and a third time, t3, at which the new lighting device is selected by a user by using the central commission device, to determine, for each new lighting device, the amount of time, Δt, elapsed from the first time, t1 to at least one of the second time, t2, and the third time, t3, and to display, on the user interface, the plurality of new lighting devices, wherein the order of the new lighting devices as displayed on the user interface is defined by the amount of time, Δt, as determined by the commissioning device.

In an embodiment of the system, each new lighting device is further configured to obtain at least one of a second time, t2, at which the network opens for lighting devices to join the network, and a third time, t3, at which the new lighting device is selected by a user by using the central commission device; and determine the amount of time, Δt, elapsed from the first time, t1 to at least one of the second time, t2, and the third time, t3, and the commissioning device is furthermore configured to obtain, for each new lighting device, the amount of time, Δt, elapsed from the first time, t1 to at least one of the second time, t2, and the third time, t3; and display on a user interface, the new lighting devices, where the order of the new lighting devices as displayed on the user interface is defined by the amount of time, Δt, as determined by the respective new lighting device.

In an embodiment of the system, the commissioning device is configured to obtain the first time, t1, by one or more of reading out the first time, t1, from each new lighting device, and detecting the first time, t1, from each new lighting device in virtue of each new lighting device being configured to measure and broadcast or unicast the first time, t1.

In an embodiment of the system, the commissioning device is configured to obtain the second time, t2, by one of reading out the second time, t2, from each new lighting device, and detecting the second time, t2, in virtue of each new lighting device being configured to measure and broadcast or unicast the second time, t2.

In an embodiment of the system, the commissioning device is configured to obtain the third time, t3, by one of reading out the third time, t3, from each new lighting device, and detecting the third time, t3, in virtue of each new lighting device being configured to measure and broadcast or unicast the third time, t3.

In an embodiment of the system, the commissioning device is configured to obtain the amount of time, Δt, by one of reading out the amount of time, Δt, from each new lighting device, and detecting the amount of time, Δt, in virtue of each new lighting device being configured to measure and broadcast or unicast the amount of time, Δt

In an embodiment of the system, each new lighting device is configured to emit light exhibiting a pattern indicative of the first time, t1, and the commissioning device comprises a detecting device configured to detect the pattern indicative of the first time, t1.

In an embodiment of the system, each new lighting device is configured to emit light exhibiting a pattern indicative of the second time, t2, and the commissioning device comprises a detecting device configured to detect the pattern indicative of the second time, t2.

In an embodiment of the system, each new lighting device is configured to emit light exhibiting a pattern indicative of the third time, t3, and the commissioning device comprises a detecting device configured to detect the pattern indicative of the third time, t3.

In an embodiment of the system, each new lighting device is configured to emit light exhibiting a pattern indicative of the amount of time, Δt, and the commissioning device comprises a detecting device configured to detect the pattern indicative of the amount of time, Δt.

In an embodiment, the system further comprises a camera positioned in such a way that the camera overlooks the area where the new lighting devices are to be mounted, and the system is further configured to: during mounting of the lighting devices, by the camera, pick up light from the new lighting devices; determine, based on the light picked up by the camera, the order in which the new lighting devices were mounted; and, based on the determined order in which the new lighting devices were mounted, turn the new lighting devices on and off one by one in order to correlate the position of the respective new lighting devices as entered in the database of the commissioning device with the actual position of the respective new lighting devices.

In an embodiment of the system, the network is a Zigbee-based network.

In an embodiment of the system, the network is a Thread-based network.

In an embodiment of the system, the network is a Wi-Fi-based network.

In an embodiment of the system, the network uses Bluetooth mesh technology.

In an embodiment of the system, the network uses Bluetooth Low Energy.

In an embodiment of the system, the commissioning device is a data processing device, such as any one of a mobile telephone, a tablet computer and a laptop computer.

In an embodiment of the system, the commissioning device comprises, and when in operation runs, a lighting device commissioning app.

In an embodiment of the system, the network further comprises a number, m, of previously added lighting devices, where m is an integer equal to or larger than 1.

It is noted that the invention relates to all possible combinations of features recited in the claims.

### BRIEF DESCRIPTION OF THE DRAWINGS

This and other aspects of the present invention will now be described in more detail, with reference to the appended drawings showing embodiment(s) of the invention.

FIG. 1 shows a schematic diagram illustrating an embodiment of a system according to the invention.

FIG. 2 shows a schematic perspective view of a number n of new lighting devices and a number m of already or previously added lighting devices.

FIG. 3 shows a schematic diagram illustrating an embodiment of a central commissioning unit of a system according to the invention.

FIG. 4 shows a block diagram illustrating a first embodiment of a method according to the invention.

FIG. 5 shows a block diagram illustrating a second embodiment of a method according to the invention.

FIG. 6 shows a block diagram illustrating further steps of a method according to the invention.

The figures are provided to illustrate the general structures of embodiments of the present invention. Like reference numerals refer to like elements throughout.

### DETAILED DESCRIPTION

The present invention will now be described more fully hereinafter with reference to the accompanying drawings, in which currently preferred embodiments of the invention are shown. This invention may, however, be embodied in many different forms and should not be construed as limited to the embodiments set forth herein; rather, these embodiments are provided for thoroughness and completeness, and fully convey the scope of the invention to the skilled person.

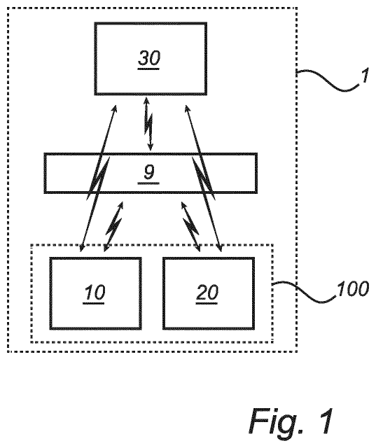

FIG. 1 schematically illustrates a lighting device system 1 according to the invention. The lighting device system 1 generally comprises a network and a number, n, of new lighting devices, which are jointly referred to with reference numeral 10, and which are to be joining or to be added to the network, where n is an integer equal to or larger than two. The system further generally comprises a commissioning device 30. The commissioning device 30 may be a central commissioning device 30.

In the embodiment shown, the lighting device system 1 further comprises an optional bridge device 9. The bridge device 9 may act as the commissioning device or the bridge device 9 may as shown in FIG. 1 act as a link between the lighting devices 10 and the commissioning device 30. In the latter case, the commissioning device 30 is connected to the bridge device 9, and the bridge device 9 is connected to the lighting devices 10 and 20, over the network. Alternatively, the bridge device 9 may be omitted in which case the commissioning device 30 is connected to and communicates directly with the lighting devices 10 and 20, over the network. The network may be any suitable type of network. The network is typically a wireless network. An often used type of network used in connection with lighting device systems 1 is a Zigbee-based network. Other feasible types of network include a Thread-based network, a Wi-Fi-based network, a network using Bluetooth mesh technology and a network using Bluetooth Low Energy.

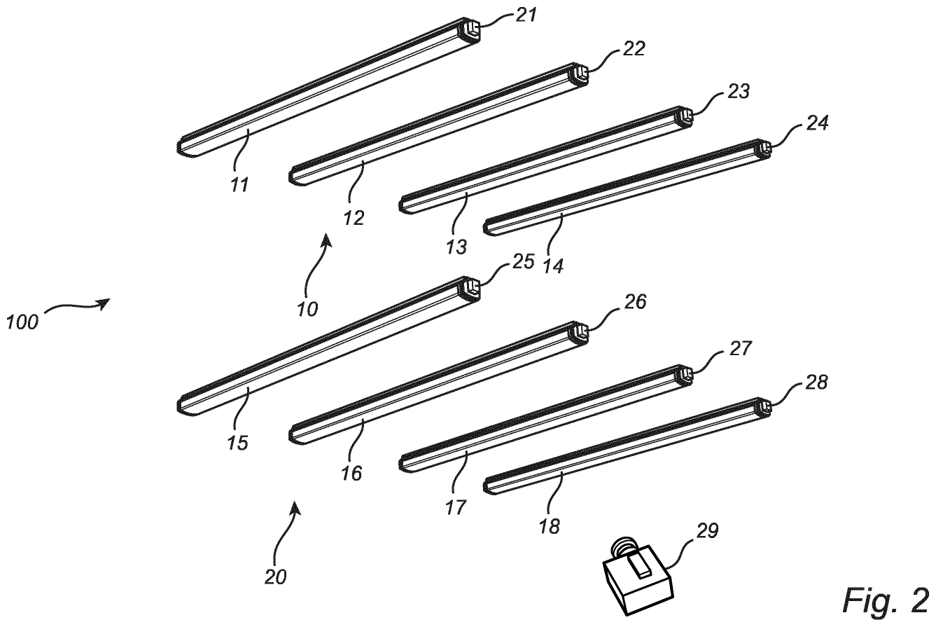

An example of a number, n, of new lighting devices 10 to be joining or to be added to the network is illustrated in FIG. 2, where n=four lighting devices 11, 12, 13, 14 are shown. As shown, the four new lighting devices 11, 12, 13, 14 are luminaires, but may also be any other type of lighting devices, such as for instance lamps. Each new lighting device 11, 12, 13, 14 may be configured to determine a first time, t1, at which the new lighting device 11, 12, 13, 14 is powered on, particularly powered on for the first time, or a value derived from the first time, t1. Each new lighting device 11, 12, 13, 14 may further comprise a device 21, 22, 23, 24 configured to store, broadcast or unicast data indicative of the first time, t1, or the value derived from the first time, t1. The device 21, 22, 23, 24 may for instance be a chip, a code, a transmitter, a broadcasting device, a unicasting device or the like. Each new lighting device 11, 12, 13, 14 may also be configured to emit light exhibiting a pattern indicative of the first time, t1, or the value derived from the first time, t1.

Optionally, the lighting device system may further comprise a number, m, of lighting devices having been added to the network before the new lighting devices 10 and thus at a previous point in time, where m is an integer equal to or larger than one. The number, m, of lighting devices will be referred to herein as previously added lighting devices and are jointly referred to with reference numeral 20.

An example of a number, m, of previously added lighting devices 20 is illustrated in FIG. 2, where m=four lighting devices 15, 16, 17, 18 are shown. As shown, the four previously added lighting devices 15, 16, 17, 18 are luminaires, but may also be any other type of lighting devices, such as for instance lamps. Each previously added lighting device 15, 16, 17, 18 may further comprise a device 25, 26, 27, 28 configured to store, broadcast or unicast data. The device 25, 26, 27, 28 may for instance be a chip, a code, a transmitter, a broadcasting device, a unicasting device or the like.

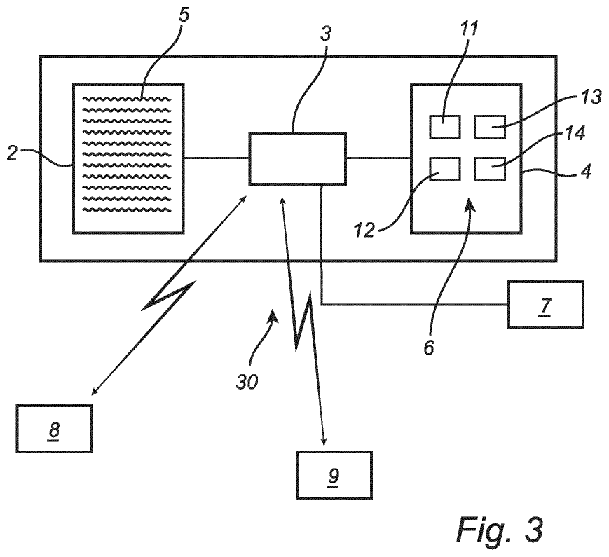

The commissioning device 30 is shown in further details in FIG. 3. The commissioning device 30 is a data processing device. A suitable commissioning app may be provided on the commissioning device 30. The commissioning device 30 may for example be any one of a mobile telephone, a tablet computer and a laptop computer. In any event, the commissioning device 30 is configured to obtain the first time, t1, at which each new lighting device 11, 12, 13, 14 was powered on, particularly powered on for the first time, or the value derived from the first time, t1. The commissioning device generally comprises a user interface 4 and is configured to display, on the user interface 4, the new lighting devices 11, 12, 13, 14 in an order 6. The order 6 of the new lighting devices 11, 12, 13, 14 as displayed on the user interface 4 is defined by the first time, t1, the respective new lighting device 11, 12, 13, 14 was powered on, or the value derived from the first time, t1, as obtained by the commissioning device 30. The commissioning device 30 may further be configured to arrange the obtained first time, t1, of each lighting device 11, 12, 13, 14, or the value derived from the first time, t1, in, for instance, an internal list. The internal list may be accessed in or via the user interface 4, by the user and/or via a suitable programmatic interface e.g. via other devices that also want to know and/or use the devices in the system 1.

Optionally, the commissioning device 30 may further be configured to obtain, for each new lighting device 11, 12, 13, 14, at least one of a second time, t2, at which the network opens for lighting devices 11, 12, 13, 14 to join the network, or a value derived from the second time, t2, and a third time, t3, at which the new lighting device 11, 12, 13, 14 is selected by a user by using the central commission device 30, or a value derived from the third time, t3, and to determine, for each new lighting device 11, 12, 13, 14, the amount of time, Δt, elapsed from the first time, t1 to at least one of the second time, t2, and the third time, t3. The commissioning device may then be configured to display, on the user interface 4, the plurality of lighting devices 11, 12, 13, 14 in an order 6 defined by the amount of time, Δt, as determined by the commissioning device 30.

It is also feasible that each new lighting device 11, 12, 13, 14 may be configured to obtain at least one of a second time, t2, at which the network opens for lighting devices 11, 12, 13, 14 to join the network, and a third time, t3, at which the new lighting device 11, 12, 13, 14 is selected by a user by using the central commission device 30, and to determine the amount of time, Δt, elapsed from the first time, t1 to at least one of the second time, t2, and the third time, t3. In such a case the commissioning device 30 may then be configured to obtain, for each new lighting device 11, 12, 13, 14, the amount of time, Δt, elapsed from the first time, t1 to at least one of the second time, t2, and the third time, t3, and to display, on the user interface 4, the new lighting devices 11, 12, 13, 14, in an order defined by the amount of time, Δt, as determined by the respective new lighting device 11, 12, 13, 14.

The commissioning device 30 may further comprise a processing unit 3 and a memory unit 2. Data 5, such as the first time t1, the second time t2, the third time t3 and the elapsed time Δt, may be stored in the memory unit 2. The data 5 may also comprise further data regarding the lighting devices 10, 20 forming part of the network, such as for example the type or model of the lighting devices, expected life-time of the lighting devices, used life-time of lighting devices and expected remaining life-time of the lighting devices.

The lighting device system 1 may further comprise or be connected wirelessly to an external memory unit 8. The commissioning device 30 may be configured to store the data 5 in the external memory unit 8.

The commissioning device 30 further optionally comprises a reading, detecting and/or receiving device 7. The device 7 may for instance be configured to read or receive data from each new lighting device 11, 12, 13, 14 and/or from the device 21, 22, 23, 24 of each new lighting device 11, 12, 13, 14 configured to store, broadcast or unicast data indicative of the first time t1. The device 7 may also be configured to detect the pattern indicative of the first time, t1, as emitted by each new lighting device 11, 12, 13, 14. The device 7 may also be configured to detect the pattern indicative of the second time, t2, as emitted by each new lighting device 11, 12, 13, 14. The device 7 may also be configured to detect the pattern indicative of the third time, t3, as emitted by each new lighting device 11, 12, 13, 14. The device 7 may also be configured to detect the pattern indicative of the amount of time, Δt, as emitted by each new lighting device 11, 12, 13, 14.

Thus, generally, the commissioning device 30 is configured to obtain the first time, t1, by one or more of reading out the first time, t1, from each new lighting device 11, 12, 13, 14, and detecting the first time, t1, from each new lighting device 11, 12, 13, 14 in virtue of each new lighting device 11, 12, 13, 14 being configured to measure and broadcast or unicast the first time, t1.

The device 7 may thus be a suitable type of detector, receiver or reader. The device 7 may also be a camera, such as in particular a camera positioned in such a way that the camera overlooks the area where the new lighting devices 11, 12, 13, 14 are to be mounted. If so, the lighting device system 1 is thereby further configured to, during mounting of the lighting devices 11, 12, 13, 14, by the camera, picking up light from the new lighting devices 11, 12, 13, 14, determining, based on the light picked up by the camera, the order in which the new lighting devices 11, 12, 13, 14 were mounted, and, based on the determined order in which the new lighting devices 11, 12, 13, 14 were mounted, turning the new lighting devices 11, 12, 13, 14 on and off one by one in order to correlate the position of the respective new lighting devices 11, 12, 13, 14 as entered in the database of the commissioning device 30 with the actual position of the respective new lighting devices 11, 12, 13, 14. In an alternative, the camera may be an external camera 29 (cf. FIG. 2) connected in a data transfer relationship with the commissioning device 30.

In the following, embodiments of a method according to the invention will be described. As a rule of thumb, lighting device commissioning procedures typically follow the following general time-line.

First a user mounts a number n of new lighting devices 10. Each new lighting device 11, 12, 13, 14 is mounted.

As a part of mounting the new lighting devices 10, the user connects each new lighting device 11, 12, 13, 14 to a power source, whereupon each new lighting device 11, 12, 13, 14 powers up as it is now connected to a power source to a first time, t1.

Next, the user uses a commissioning device 30 to open up the network for the new lighting devices to join. The lighting devices 11, 12, 13, 14 and/or the commissioning device 30 note this time as a second time, t2.

After the new lighting devices 11, 12, 13, 14 have joined the network, the user can use the commissioning device 30 to select one or more of the lighting devices 11, 12, 13, 14. The commissioning device 30 can then communicate with that or those lighting devices 11, 12, 13, 14. The lighting devices 11, 12, 13, 14 and/or the commissioning devoice 30 note this as a third time, t3.

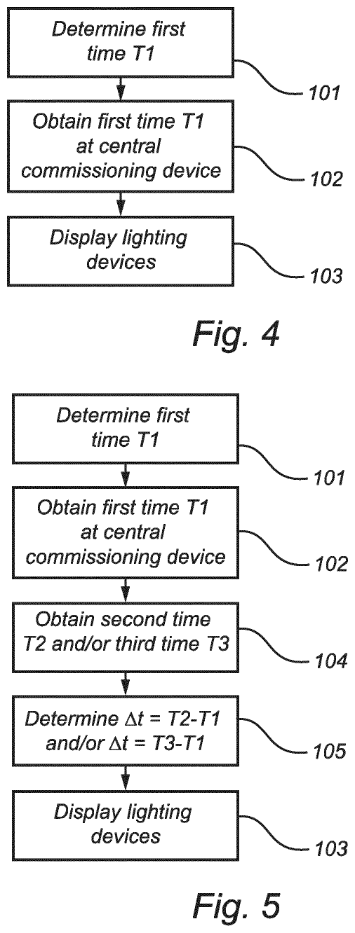

Turning now to FIG. 4, a method of commissioning of a number, n, of new lighting devices 10 joining or being added to a network according to a first embodiment of the invention is shown. Generally, the method according to the invention comprises the following steps.

In a first step 101, a first time, t1, at which the new lighting device is powered on, is determined for each new lighting device, at or by the new lighting device.

In a second step 102, the first time, t1, at which each new lighting device was powered on is obtained by the commissioning device 30. For instance, the commissioning device 30 may read, detect or receive the first time, t1.

In a third step 103, the commissioning device 30 displays, on a user interface 4, the new lighting devices 11, 12, 13, 14 in an order 6 defined by the first time, t1, the respective new lighting device 11, 12, 13, 14 was powered on as obtained by the commissioning device 30.

In step 102, the first time, t1, may be obtained by the commissioning device 30 reading out the first time, t1, from each new lighting device 11, 12, 13, 14. Alternatively, or additionally, each new lighting device 11, 12, 13, 14 may measure and broadcast or unicast the first time, t1, which may then be detected by the commissioning device 30 using a detecting device 7 in the form of a suitable receiver, or be received by the communication interface.

The first time, t1, may alternatively be determined by the light emitted by a new lighting device 11, 12, 13, 14 exhibiting a pattern indicative of the first time, t1, and the commissioning device 30 may then detect the pattern indicative of the first time, t1, using a suitable detecting device 7. The pattern indicative of the first time, t1, may be a visual light communication (VLC) pattern or a stroboscopic pattern. The detecting device 7 is then a camera. The second time, t2, and/or the third time, t3, may optionally be determined in a similar manner as described above for the first time, t1.

The first time, t1, may alternatively be determined by a new lighting device 11, 12, 13, 14 exhibiting a pattern indicative of the first time, t1, and the commissioning device 30 may then detect the pattern indicative of the first time, t1, using a suitable detecting device 7. The pattern indicative of the first time, t1, may be a Bluetooth low energy (BLE) beacon pattern. The detecting device 7 is then a BLE receiver. The second time, t2, and/or the third time, t3, may optionally be determined in a similar manner as described above for the first time, t1.

FIG. 5 illustrates a second embodiment of a method according to the invention. The method illustrated in FIG. 5 differs from that above in that it comprises two additional steps which are performed between steps 102 and 103 described above.

Following steps 101 and 102, in a fourth step 104, the commissioning device 30 obtains, for each new lighting device 11, 12, 13, 14, at least one of a second time, t2, at which the network opens for lighting devices 11, 12, 13, 14 to join the network, and a third time, t3, at which the new lighting device 11, 12, 13, 14 is selected by a user by using the central commission device.

Thereupon, in a fifth step 105, the commissioning device 30 determines, for each new lighting device 11, 12, 13, 14, the amount of time, Δt, elapsed from the first time, t1 to at least one of the second time, t2, and the third time, t3.

The method then continues to step 103, in which the commissioning device 30, on the user interface, displays the new lighting devices 11, 12, 13, 14 in a predetermined order 6. The order 6 of the new lighting devices 11, 12, 13, 14 as displayed on the user interface 4 is now defined by the amount of time, Δt, as determined by the commissioning device 30.

In an alternative, it is also feasible that in step 104 each new lighting device 11, 12, 13, 14 obtains at least one of a second time, t2, at which the network opens for lighting devices 11, 12, 13, 14 to join the network, and a third time, t3, at which the new lighting device 11, 12, 13, 14 is selected by a user by using the central commission device 30, and in step 105 determines the amount of time, Δt, elapsed from the first time, t1 to at least one of the second time, t2, and the third time, t3. In such a case the method then continues to an intermediate step in which the commissioning device 30 obtains, for each new lighting device 11, 12, 13, 14, the amount of time, Δt, elapsed from the first time, t1 to at least one of the second time, t2, and the third time, t3, and further to step 103 in which the commissioning device 30 displays, on the user interface 4, the new lighting devices 11, 12, 13, 14, in an order defined by the amount of time, Δt, as determined by the respective new lighting device 11, 12, 13, 14.

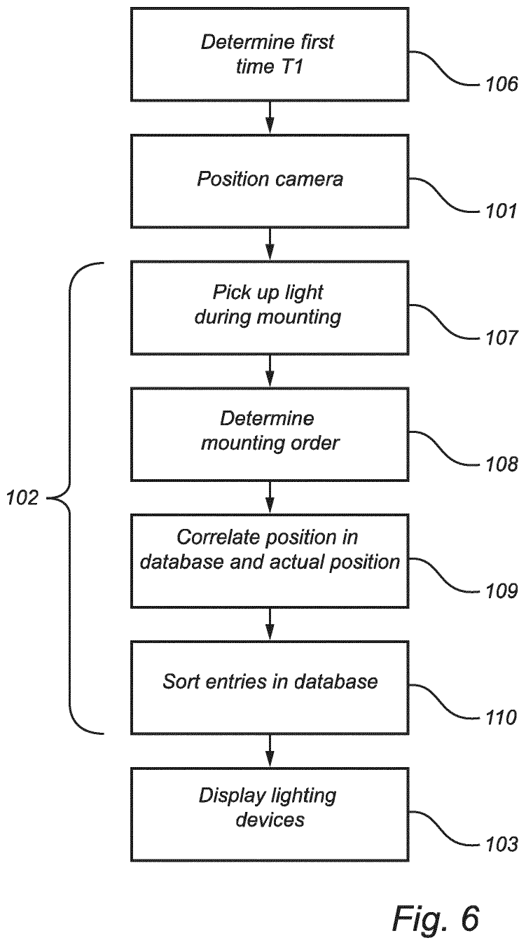

FIG. 6 illustrates a third embodiment of a method according to the invention. The method illustrated in FIG. 6 differs from that above and illustrated in FIG. 4 in that step 102 is performed in a different manner, namely by performing steps 107-110 as described below.

First, in step 106 a camera 7, 29 is positioned in such a way that the camera overlooks the area where the new lighting devices 11, 12, 13, 14 are to be mounted. The camera 7, 29 may be a camera 7 forming part of the commissioning device 30, or it may be an external camera 29 (cf. FIG. 2) connected in a data transfer relationship with the commissioning device 30.

Then, the method continues with step 101 as described above.

Next, in step 107, during mounting of the lighting devices, light from the new lighting devices 11, 12, 13, 14 is picked up by the camera 7, 29. Data corresponding to or indicative of the light picked up by the camera 7, 29 is obtained by the commissioning device 30, such as transmitted by the camera 7, 29 and received by the commissioning device 30.

In step 108, the order in which the new lighting devices 11, 12, 13, 14 were mounted is determined based on the light picked up by the camera 7, 29. Step 108 is performed by the commissioning device 30.

In step 109, based on the determined order in which the new lighting devices 11, 12, 13, 14 were mounted, the new lighting devices 11, 12, 13, 14 controlled, such as for instance turned on and off, one by one, by the commissioning device 30, in order to correlate the position of the respective new lighting devices 11, 12, 13, 14 as entered in the database of the commissioning device 30 with the actual position of the respective new lighting devices 11, 12, 13, 14.

Finally, in step 110, based on the correlated positions, the entries for the new lighting devices 11, 12, 13 in the database of the commissioning device 30 are sorted in the determined order in which the new lighting devices 11, 12, 13, 14 were mounted.

The method may continue to step 103 as described above either before or after step 110.

The person skilled in the art realizes that the present invention by no means is limited to the preferred embodiments described above. On the contrary, many modifications and variations are possible within the scope of the appended claims.

Additionally, variations to the disclosed embodiments can be understood and effected by the skilled person in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measured cannot be used to advantage.

1. A method of commissioning of a number, n, of new lighting devices joining or being added to a network, where n is an integer equal to or larger than 2, where the network comprises a commissioning device, and wherein the method comprises:
determining, for each new lighting device, at or by the new lighting device, a first time, t1, the first time, t1, being the time when the new lighting device is powered on, or a value derived from the first time, t1,
obtaining, by the commissioning device, the first time, t1, or the value derived from the first time, t1, and
displaying, by the commissioning device, on a user interface, the new lighting devices, wherein the order of the new lighting devices as displayed on the user interface is defined by the first time, t1, or the value derived from the first time, t1, as obtained by the commissioning device.

2. A method according to claim 1, wherein the first point in time is any one of:
the time at which the respective new lighting device is powered on for the first time, and
the time at which the respective new lighting device is powered on for the first time after the respective new lighting device has been reset to factory default settings.

3. A method according to claim 1, wherein the method further comprises:
obtaining, by the commissioning device, for each new lighting device, at least one of a second time, t2, at which the network opens for lighting devices to join the network, and a third time, t3, at which the new lighting device is selected by a user by using the central commission device,
determining, by the commissioning device, for each new lighting device, the amount of time, Δt, elapsed from the first time, t1 to at least one of the second time, t2, and the third time, t3, and,
displaying, by the commissioning device, on a user interface, the new lighting devices, wherein the order of the new lighting devices as displayed on the user interface is defined by the amount of time, Δt, as determined by the commissioning device,
or wherein the method further comprises:
for each new lighting device, at each new lighting device, obtaining at least one of a second time, t2, at which the network opens for lighting devices to join the network, and a third time, t3, at which the new lighting device is selected by a user by using the central commission device;
determining, by each new lighting device, the amount of time, Δt, elapsed from the first time, t1 to at least one of the second time, t2, and the third time, t3;
obtaining, by the commissioning device, for each new lighting device, the amount of time, Δt, elapsed from the first time, t1 to at least one of the second time, t2, and the third time, t3; and,
displaying, by the commissioning device, on a user interface, the new lighting devices, where the order of the new lighting devices as displayed on the user interface is defined by the amount of time, Δt, as determined by the respective new lighting device.

4. A method according to claim 1, wherein one or more of the following applies:
the first time, t1, is obtained by any one of the commissioning device reading out the first time, t1, from each new lighting device, and each new lighting device measuring and broadcasting or unicasting the first time, t1,
the second time, t2, is obtained by any one of the commissioning device reading out the second time, t2, from each new lighting device, and each new lighting device measuring and broadcasting or unicasting the second time, t2,
the third time, t3, is obtained by any one of the commissioning device reading out the third time, t3, from each new lighting device, and each new lighting device measuring and broadcasting or unicasting the third time, t3, and
the amount of time, Δt, elapsed from the first time, t1 to at least one of the second time, t2, the third time, t3, and the amount of time, Δt, is obtained by any one of the commissioning device reading out the amount of time, Δt, and each new lighting device measuring and broadcasting or unicasting the amount of time, Δt.

5. A method according to claim 4, wherein one or more of the following applies:
the first time, t1, is determined by the light emitted by a new lighting device exhibiting a pattern indicative of the first time, t1, and the commissioning device comprising a detecting device configured to detect the pattern indicative of the first time, t1,
the second time, t2, is determined by the light emitted by a new lighting device exhibiting a pattern indicative of the second time, t2, and the commissioning device comprising a detecting device configured to detect the pattern indicative of the second time, t2,
the third time, t3, is determined by the light emitted by a new lighting device exhibiting a pattern indicative of the third time, t3, and the commissioning device comprising a detecting device configured to detect the pattern indicative of the third time, t3, and
the amount of time, Δt, is determined by the light emitted by a new lighting device exhibiting a pattern indicative of the amount of time, Δt, and the commissioning device comprising a detecting device configured to detect the pattern indicative of the amount of time, Δt.

6. A method according to any one of claim 5, wherein any one or more of the pattern indicative of the first time, t1, the pattern indicative of the second time, t2, the pattern indicative of the third time, t3, and the pattern indicative of the amount of time, Δt, is any one or more of a visual light communication, VLC, pattern and a stroboscopic pattern, and wherein the detecting device is a camera.

7. A method according to claim 1, wherein displaying, by the commissioning device, on a user interface, the new lighting devices comprises entering the lighting devices into a database in ascending order of the obtained first time, t1, or in descending order of the determined amount of time, Δt, such that the order in which the new lighting devices are displayed on the user interface will match the order in which the new lighting devices were powered on.

8. A method according to claim 1, wherein the new lighting devices join or are added to the network in a random order.

9. A method according to claim 1, wherein the new lighting devices join or are added to the network with a delay, k*(t2−t1), the delay being chosen such that the new lighting devices will join or are added to the network in the order in which they were powered up.

10. A method according to claim 1, and further comprising:
positioning a camera in such a way that the camera overlooks the area where the new lighting devices are to be mounted,
during mounting of the lighting devices, by the camera, picking up light from the new lighting devices,
determining, based on the light picked up by the camera, the order in which the new lighting devices were mounted, and,
based on the determined order in which the new lighting devices were mounted, control the new lighting devices one by one in order to correlate the position of the respective new lighting devices as entered in the database of the commissioning device with the actual position of the respective new lighting devices.

11. A method according to claim 10, and further comprising, based on the correlated positions, sorting the entries for the new lighting devices in the database of the commissioning device in the determined order in which the new lighting devices were powered on.

12. A lighting device system comprising a network and a number, n, of new lighting devices to be joining or to be added to the network, where n is an integer equal to or larger than 2,
the network comprising a commissioning device, and wherein: each new lighting device, is configured to determine a first time, t1, at which the new lighting device is powered on, or a value derived from the first time, t1,
the commissioning device is configured to obtain the first time, t1, or the value derived from the first time, t1, and
the commissioning device is configured to display, on a user interface, the new lighting devices, wherein the order of the new lighting devices as displayed on the user interface is defined by the first time, t1, or the value derived from the first time, t1.

13. A system according to claim 12, wherein the commissioning device (30) furthermore is configured to:
obtain, for each new lighting device, at least one of a second time, t2, at which the new lighting device is selected by a user by using the central commission device, and a third time, t3, at which the new lighting device is selected by a user by using the central commission device,
determine, for each new lighting device, the amount of time, Δt, elapsed from the first time, t1 to at least one of the second time, t2, and the third time, t3, and,
display, on the user interface, the plurality of new lighting devices, wherein the order of the new lighting devices as displayed on the user interface is defined by the amount of time, Δt, as determined by the commissioning device,
or wherein:
each new lighting device is further configured to:
obtain at least one of a second time, t2, at which the network opens for lighting devices to join the network, and a third time, t3, at which the new lighting device is selected by a user by using the central commission device; and
determine the amount of time, Δt, elapsed from the first time, t1 to at least one of the second time, t2, and the third time, t3, and
the commissioning device is furthermore configured to:
obtain, for each new lighting device, the amount of time, Δt, elapsed from the first time, t1 to at least one of the second time, t2, and the third time, t3; and
display on a user interface, the new lighting devices, where the order of the new lighting devices as displayed on the user interface is defined by the amount of time, Δt, as determined by the respective new lighting device.

14. A system according to claim 12, wherein one or more of the following applies:
the commissioning device is configured to obtain the first time, t1, by one of reading out the first time, t1, from each new lighting device, and detecting the first time, t1, from each new lighting device in virtue of each new lighting device being configured to measure and broadcast or unicast the first time, t1,
the commissioning device is configured to obtain the second time, t2, by one of reading out the second time, t2, from each new lighting device, and detecting the second time, t2, in virtue of each new lighting device being configured to measure and broadcast or unicast the second time, t2,
the commissioning device is configured to obtain the third time, t3, by one of reading out the third time, t3, from each new lighting device, and detecting the third time, t3, in virtue of each new lighting device being configured to measure and broadcast or unicast the third time, t3, and
the commissioning device is configured to obtain the amount of time, Δt, by one of reading out the amount of time, Δt, from each new lighting device, and detecting the amount of time, Δt, in virtue of each new lighting device being configured to measure and broadcast or unicast the amount of time, Δt.

15. A system according to claim 12, wherein one or more of the following applies:
each new lighting device is configured to emit light exhibiting a pattern indicative of the first time, t1, and the commissioning device comprises a detecting device configured to detect the pattern indicative of the first time, t1,
each new lighting device is configured to emit light exhibiting a pattern indicative of the second time, t2, and the commissioning device comprises a detecting device configured to detect the pattern indicative of the second time, t2,
each new lighting device is configured to emit light exhibiting a pattern indicative of the third time, t3, and the commissioning device comprises a detecting device configured to detect the pattern indicative of the third time, t3, and
each new lighting device is configured to emit light exhibiting a pattern indicative of the amount of time, Δt, and the commissioning device comprises a detecting device configured to detect the pattern indicative of the amount of time, Δt.
